(19) United States
(12) Patent Application Publication
(10) Pub. No.: US 2015/0084837 A1
(43) Pub. Date: Mar. 26, 2015

(54) COORDINATION OF MULTIPLE MOBILE DEVICE DISPLAYS

(71) Applicant: Broadcom Corporation, Irvine, CA (US)

(72) Inventor: Murat Mese, Rancho Palos Verdes, CA (US)

(73) Assignee: Broadcom Corporation, Irvine, CA (US)

(21) Appl. No.: 14/037,184

(22) Filed: Sep. 25, 2013

(51) Int. Cl. G06F 3/14; G09G 3/20

(52) U.S. Cl. CPC G06F 3/1446; G09G 3/2096; G09G 2300/026; G09G 2370/16
USPC 345/1.3

(57) ABSTRACT

Methods, systems, and apparatuses are described for coordination of multiple mobile device displays to display any image(s) so that each device displays an image based on its relative position in an arrangement of a plurality of mobile devices. Random configurations of uniform and non-uniform mobile device displays may be adapted as display elements in a larger display or in a related display, such as game pieces.

### CROSS-REFERENCE TO RELATED APPLICATIONS

This application claims priority to provisional U.S. Patent Application No. 61/880,065, filed Sep. 19, 2013, the entirety of which is incorporated by reference herein.

### BACKGROUND

1. Technical Field

The subject matter described herein relates to mobile device displays. In particular, the subject matter described herein relates to coordination of multiple mobile device displays.

2. Description of Related Art

A common complaint is that display screens on mobile devices are too small. However, the larger displays become, the less mobile the “mobile” devices become. A larger fixed display, e.g., a desktop display, is often unavailable. Thus, there is a need for mobile users to retain the mobility of their mobile devices while having alternative displays.

### BRIEF SUMMARY

Methods, systems, and apparatuses are described for coordinating multiple mobile device displays, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate a plurality of embodiments and, together with the description, further serve to explain the principles involved and to enable a person skilled in the pertinent art(s) to make and use the disclosed technologies. However, embodiments of the disclosed technologies are not limited to the specific implementations disclosed herein. Unless expressly indicated by common numbering, each figure represents a different embodiment where components and steps in each embodiment are intentionally numbered differently.

FIG. 1 shows a block diagram of an exemplary embodiment of a system that coordinates multiple mobile device displays.

FIGS. 2a and 2b show exemplary two-dimensional and three-dimensional arrangements of mobile devices, respectively.

FIG. 3 shows a block diagram of an exemplary computer that may coordinate multiple mobile device displays.

FIG. 4 shows a flowchart of an exemplary embodiment of a method for coordinating multiple mobile device displays.

FIG. 5 shows an exemplary image that may be displayed by coordinated mobile device displays.

FIG. 6 shows an exemplary mode of displaying the image shown in FIG. 5 by a plurality of coordinated mobile device displays that are the same.

FIG. 7 shows an exemplary mode of displaying the image shown in FIG. 5 by a plurality of coordinated mobile device displays that are different.

FIGS. 8a, 8b, and 8c show an exemplary mode of displaying the image shown in

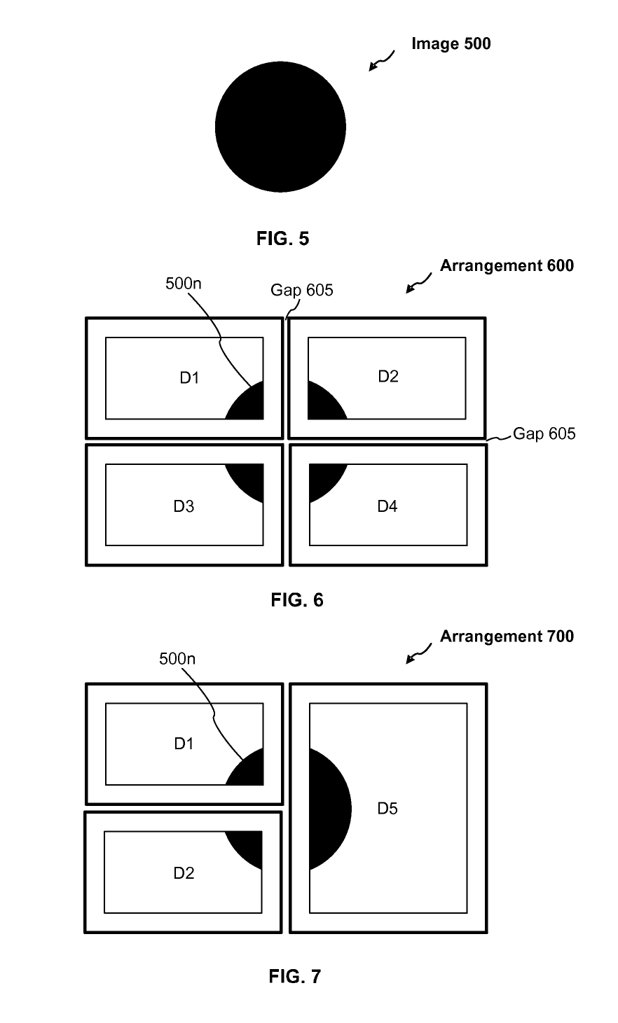

FIG. 5 by a plurality of coordinated mobile device displays.

FIGS. 9a, 9b, 9c and 9d show an exemplary mode of displaying related images by a plurality of coordinated mobile device displays.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

Reference will now be made to embodiments that incorporate features of the described and claimed subject matter, examples of which are illustrated in the accompanying drawings. While the technology will be described in conjunction with various embodiments, it will be understood that the embodiments are not intended to limit the present technology. The scope of the subject matter is not limited to the disclosed embodiment(s). On the contrary, the present technology is intended to cover alternatives, modifications, and equivalents, which may be included within the spirit and scope the various embodiments as defined herein, including by the appended claims. In addition, in the following detailed description, numerous specific details are set forth in order to provide a thorough understanding of the present technology. However, the present technology may be practiced without these specific details. In other instances, well-known methods, procedures, components, and circuits have not been described in detail as not to unnecessarily obscure aspects of the embodiments presented.

References in the specification to “embodiment,” “example,” or the like indicate that the subject matter described may include a particular feature, structure, characteristic, or step. However, other embodiments do not necessarily include the particular feature, structure, characteristic or step. Moreover, “embodiment,” “example,” or the like do not necessarily refer to the same embodiment. Further, when a particular feature, structure, characteristic or step is described in connection with an embodiment, it is submitted that it is within the knowledge of one skilled in the art to effect such feature, structure, or characteristic in connection with other embodiments whether or not those other embodiments are explicitly described.

Certain terms are used throughout the following description and claims to refer to particular system components and configurations. As one skilled in the art will appreciate, various skilled artisans and companies may refer to a component by different names. The discussion of embodiments is not intended to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection or through an indirect electrical connection via other devices and connections.

Methods, systems, and apparatuses will now be described for coordination of multiple mobile device displays so that each mobile device displays an image based on its relative position in an arrangement of a plurality of mobile devices. Random configurations of uniform and non-uniform mobile device displays may be adapted as display elements in a larger display or in a related display, such as game pieces. Many embodiments of systems, devices and methods may be implemented, each with various configurations and/or steps. While several detailed features and embodiments are discussed below, many more embodiments are possible. In Section II, an overview of coordination of multiple mobile device displays is described. In Section III, an exemplary multi-display coordination system is described. In Section IV, an exemplary computer is described. In Section V, an exemplary method of coordinating multiple mobile device displays is described. In Section VI, exemplary display modes are described. In Section VII, a conclusion is provided. Section headings are non-limiting guides and do not restrict the disclosure in any way.

### II. Overview of Coordination of Multiple Mobile Device Displays

The technology herein generally addresses the problem that display screens on mobile devices are too small. However, because people often have more than one mobile device and/or congregate with other people with one or more mobile devices, multiple mobile devices may be aggregated and arranged to form a larger display or related displays to display images, where an image is defined as any visual content. Images displayed by coordinated displays may be pre-divided for a plurality of mobile devices, may be partitioned and distributed among the plurality of mobile devices or each mobile device may select an image or a portion of an image so that each mobile device displays an image, or portion thereof, based on its relative position in an arrangement of a plurality of mobile devices. As a result of display coordination, random configurations of mobile device displays may be adapted as display elements in a larger display or in a related display, such as game pieces, for passive viewing or interactive use by one or more viewers or users. Non-limiting examples of passive viewing include the display of pictures, videos, movies, and Web pages while non-limiting examples of interactive use include playing games (e.g. puzzles, reaction time games and video games).

The subject technology can be used with a wide variety of mobile device types, including but not limited to wireless devices, such as cell phones (e.g. smartphones, non-smartphones), tablets, mini notebooks, notebooks, netbooks, laptops, media players, etc. Devices may be uniform (i.e. the same) or non-uniform (i.e. different).

Configurations or arrangements of device displays may be two-dimensional (2D) or three-dimensional (3D). Non-limiting examples of 2D shapes include straight, meandering, sinusoidal, rectangular, square and circular. Non-limiting examples of 3D shapes include spherical, cubical, 3D-circular (wheel) and conical. Arrangements may be freeform or organized. Organized arrangements may use forms, such as racks/mounts, that hold devices in a particular shape or pattern.

In view of an infinite number of random or ad hoc, static and dynamic arrangements of mobile devices as multi-screen displays and given a variety of image applications and display modes, the configuration, organization or physical arrangement of aggregated mobile devices, i.e., device alignment, such as the number of devices, their relative positions and orientations, is detected and used to determine what image, or what portion of an image, each mobile device will display in accordance with an image application and available display modes. Certain information may be more or less relevant to various image applications. For example, aggregated mobile devices may be used by some image applications, such as puzzle games, to display related images, such as different game pieces, while aggregated mobile devices may be used by other image applications, such as video applications, to display a portion of a divided image to present viewers with a larger image. For the latter type of image applications, an aggregate display shape formed by a plurality of mobile device displays (i.e. screens) may be relevant to determine display mode, image scaling and image partitioning.

Device arrangement/alignment may be detected by sensing data and interpreting or analyzing the sensed data. Arrangement of devices may be discovered using general purpose or location-specific sensors. A non-limiting example of a general purpose sensor is a wireless transceiver. Non-limiting examples of location-specific sensors include gyro, accelerometer, proximity, compass and global positioning system (GPS) sensors.

In one embodiment, communications by mobile devices using one or more transceivers may be analyzed in combination with device information to determine the display arrangement. For example, distance between communication transceivers may be determined by analyzing timestamps in communications for propagation delays. Data may be sensed and analyzed periodically or in response to a trigger event, such as movement sensed by one or more sensors. Power savings can advantageously be achieved in embodiments in which the data sensing and analysis is triggered by movement, as such data sensing and analysis may be performed less frequently when the mobile devices are immobile. One or more devices, including all devices, and/or a server may comprise one or more image applications that determine an aggregate display and display processing. Image processing may be performed by a server, by one device or by each device in the arrangement, such as where each device receives an entire image and each device determines what portion of the image the device should display.

Image applications may have one or more display modes offering different viewing perspectives and image processing. For example, a viewing perspective may account for or ignore non-display area (e.g. device frames, protective covers and gaps between devices) relative to the aggregate display. If non-display area is considered part of the aggregate display, then portions of an overall image would be appear to be missing, i.e., hidden as if looking through a window divided with muntins.

Device information, such as dimensions (e.g. frame and display size), processor, memory, transceiver (number and location), etc. can be associated with an image application on one or more devices and/or a server in any format, such as a table. Alternatively, devices may discover such information, e.g. during handshaking.

In comparison to large commercial displays with an array of display elements that are fixed in place, uniform, singular-purpose and do not operate independently, this technology adapts multi-purpose devices that are mobile, independently operable, uniform and non-uniform, as ad hoc display elements in random display configurations.

### III. Exemplary Embodiments of Coordination of Multiple Mobile Device Displays

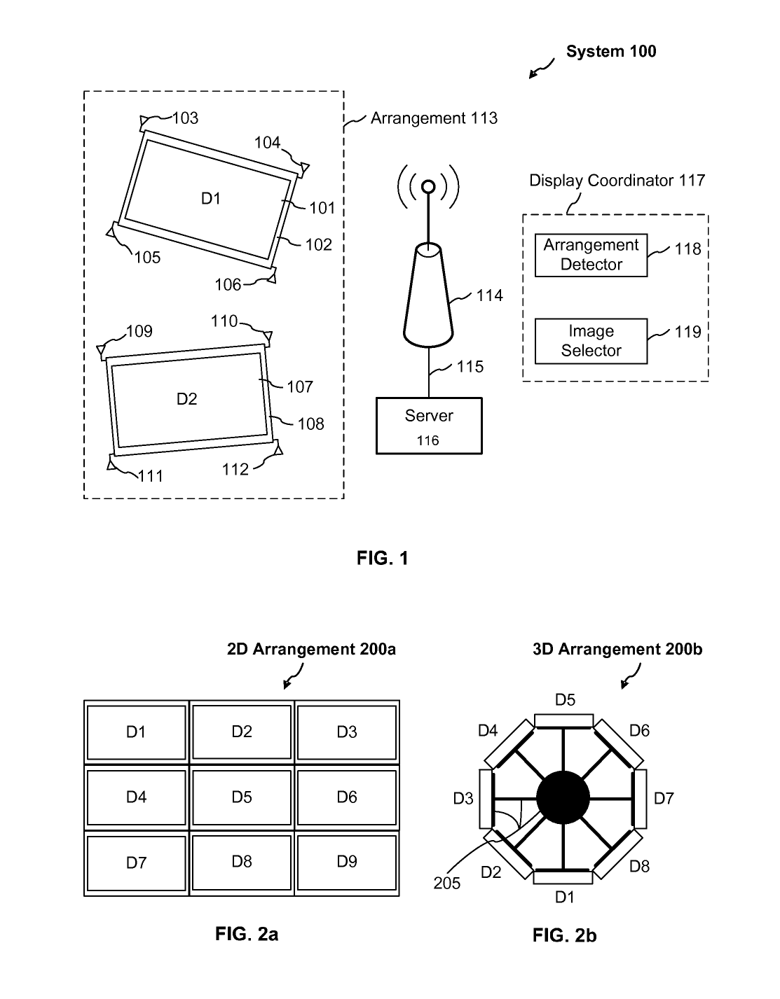

FIG. 1 shows a block diagram of an exemplary embodiment of a system 100 that coordinates multiple mobile device displays. System 100 is merely one exemplary system out of many possible systems. In other embodiments, system 100 may comprise more or fewer components. System 100 comprises mobile device arrangement 113, display coordinator 117 and optional communication device 114, communication medium 115 and server 116. Other embodiments may comprise more or fewer components.

Arrangement 113 shows first mobile device D1 and second mobile device D2. In various embodiments, arrangement 113 may comprise any physical arrangement of any number and type of mobile devices. First and second devices D1, D2, and other devices forming part of arrangement 113 or any other arrangement, may be arranged in 2D or 3D. FIGS. 2a and 2b show exemplary two-dimensional and three-dimensional arrangements of mobile devices. In FIG. 2a, nine devices, including first through ninth devices D1-D9, are shown in rectangular arrangement 200a with very little or no space between frames of first through ninth devices D1-D9. Rectangular arrangement 200a may be suitable, for example, as an aggregate display of pictures, videos and video games. Of course, many other 2D arrangements are possible in terms of shapes, spacing, orientations, number of devices, etc. In FIG. 2b, eight devices, including first through eight devices D1-D8, are shown in 3D circular arrangement 200b. In this embodiment, first through eight devices D1-D8 are shown affixed to 3D circular mount 205. Circular arrangement 200b may be suitable, for example, in 3D interactive games (e.g. showing an airplane traversing 3D space), 3D imagery/lighting (e.g. disco ball). Of course, many other 3D arrangements are possible, with and without a mount, in terms of shapes, spacing, orientations, number of devices, etc.

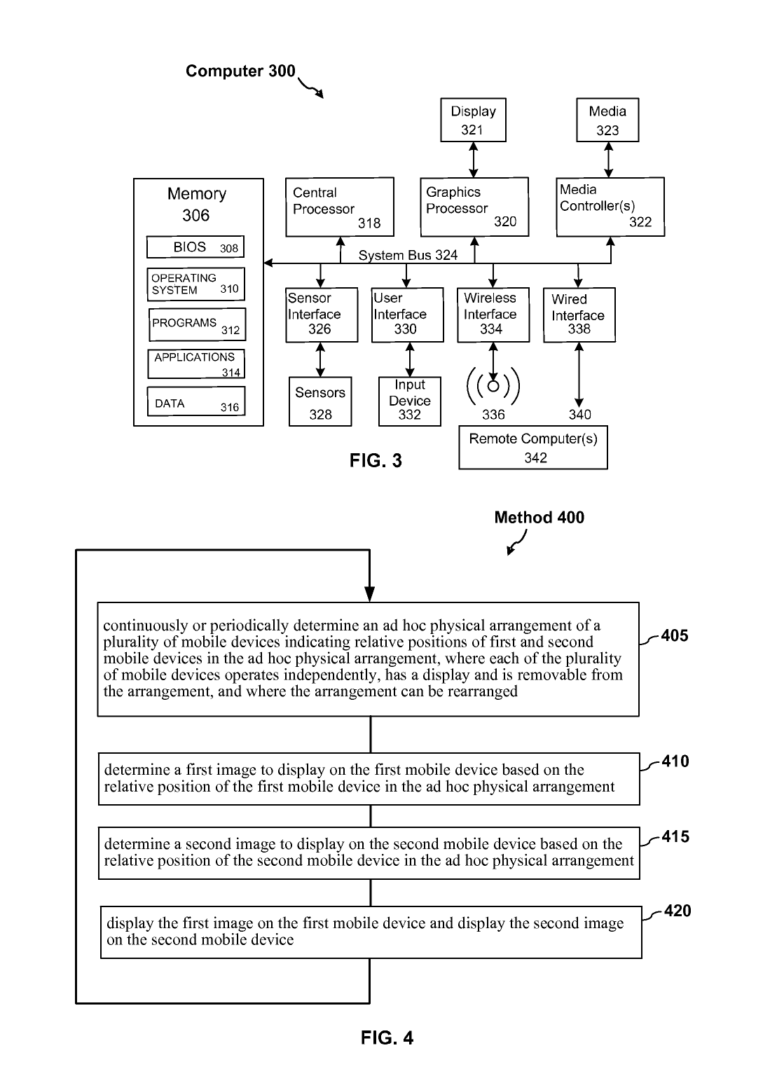

First mobile device D1 comprises display 101, frame 102 and first through fourth transceivers 103, 104, 105 and 106. Second mobile device D2 comprises display 107, frame 108 and first through fourth transceivers 109, 100, 111 and 112. First and second mobile devices D1, D2, and other mobile devices in other embodiments, may each comprise a computer. A non-limiting example of a computer is computer 300 shown in FIG. 3. First and second devices D1, D2 may communicate with each other via one or more transceivers 103-106, 109-112. Displays 101, 107 may comprise any type of display, including a touch screen display. Transceivers 103-106, 109-112, may transmit and receive wireless communications at any frequency using any one or more communication technology protocols. Non-limiting examples of communication protocols include near field communication (NFC), radio frequency identification (RFID), Wireless Local Area Network (WLAN), e.g., WiFi operating based on IEEE 802.11 standards and WiMax operating based on IEEE 802.16 standards, 60 GHz wireless protocols, Bluetooth (BT), Wireless USB (WUSB), and any cellular technology, e.g., Advanced Mobile Phone (“AMPS”), digital AMPS, Global System for Mobile communications (“GSM”), Code Division Multiple Access (“CDMA”), Local Multi-point Distribution Systems (“LMDS”), Universal Mobile Telecommunications System (UMTS), Long Term Evolution (“LTE”), Multi-channel-Multi-point Distribution System (MMDS), or other cellular services, and/or variations thereof First and second devices D1, D2 may have any number of transceivers, supporting communication components such as receivers, transmitters and antennas, sensors and other components and features (not shown). Non-limiting examples of sensors in first and second devices D1, D2 include gyro, accelerometer, proximity, compass and global positioning system (GPS) sensors.

System 100 further comprises communication device 114 and server 116 coupled by communication medium(s) 115. Communication device 114 may comprise any fixed or mobile wireless transceiver operating at any frequency using any wireless communication technology that communicates with at least one of first device D1 and second device D2. Non-limiting examples of communication device 114 include an access point (AP) and a cellular base station. Non-limiting examples of wireless communication technology include the examples provided for first and second devices D1, D2. Communication medium(s) 115 comprise any wireless and/or wired communication medium, e.g., optical fiber, using any communication protocol.

Communication medium(s) 115 may comprise multiple networks, including but not limited to LANs, WLANs, intranet(s), and internet(s) that may or may not be coupled to the world wide web (WWW). Server 116 comprises one or more computers. A non-limiting example of a computer is computer 300 shown in FIG. 3. Server 116 may communicate with first device D1 and/or second device D2 via communication medium(s) 115, communication device 114 and one or more transceivers 103-106, 109-112.

System 100 further comprises display coordinator 117. Display coordinator coordinates the display of an image or related images on first and second devices D1, D2 and any other devices forming part of arrangement 113. In some embodiments, such as the one depicted in FIG. 1, display coordinator 117 comprises several modules, including but not limited to arrangement detector 118 and image selector 119.

Each device in an arrangement may provide an indication that they are participating in an arrangement. As one of many possible examples, each device may run a display coordination application. Any portion or all of display coordinator 117 may be implemented in any one or more of first device D1, second device D2 and server 116. Any portion or all of display coordinator 117 may be repeated in each of first device D1, second device D2 and server 116. Display coordinator 117 may be implemented in digital hardware, analog hardware, firmware, software or any combination thereof. For example, first device D1 may perform display coordination and provide the portion of an image or a related image to D2. As another example, each of first and second devices D1 and D2 can perform display coordination for themselves based on image(s) they have or image(s) provided by another device. As another example, server 116 can perform display coordination and provide respective image(s) to first and second devices D1, D2. In some embodiments, display coordinator 113 may be split among an operating system and one or more applications. There are a wide variety of options to centralize and distribute various functions involved in display coordination.

Arrangement detector 118 detects the arrangement/alignment of first and second devices D1, D2, and any other devices forming part of arrangement 113, by interpreting or analyzing data generated by one or more general or specific purpose sensors, including but not limited to one or more wireless transceivers, gyros, accelerometers, proximity sensors, compasses and global positioning system (GPS) sensors.

In one embodiment, communications by first and second devices D1, D2 with each other and/or with communication device 114 using selected transceivers 103-106, 109-112 may be analyzed in combination with information about first and second devices D1, D2 and/or communication device 114 to determine the display arrangement, e.g. arrangement 113. For example, distance between selected first device D1 transceivers 103-106, second device D2 transceiver 109-112 and/or communication device 114 may be determined by analyzing timestamps in those communications for propagation delays. For timestamp techniques to determine distance and, ultimately, relative positions of devices in arrangement 113, first device D1, second device D2 and/or communication device 114 may need to be time synchronized. For example, each participating device may maintain a timing synchronization function (TSF) with a TSF timer in microsecond increments. In some embodiments, time synchronization may be implemented in accordance with an audio video bridging (AVB) standard for IEEE 802 communications.

Distance and relative positioning determinations based on communications, without limitation and with varying levels of precision, include time of arrival (TOA), time distance of arrival (TDOA), round trip time (RTT), angle of arrival (AOA) and received signal strength indicator (RSSI). These and other techniques may be implemented alone or in combination to determine distances and relative positions of devices in an arrangement. TOA, TDOA and RTT may be determined from timestamp difference (TSD). In some embodiments, TSD may be the time difference between the time that an acknowledgement of a frame is sent/received minus the time that the frame was originally sent/received, as measured on a single station (e.g. mobile or fixed station), such as first device D1, second device D2 or communication device 114. In other embodiments, TSD may be defined differently.

Regardless of technique(s), raw data for distance and relative position calculations may be sensed and analyzed periodically or in response to a trigger event, such as movement sensed by one or more sensors. Device information to determine an arrangement of devices, such as but not limited to dimensions (e.g. frame and display size), processor, memory, transceiver (number and location), implemented in any format (e.g. a table) can be associated with or otherwise accessible by display coordinator 117. Alternatively, this information may be discovered during device communications, such as during handshaking. Thus, communications between devices in an arrangement may be dual purpose. The communications may provide discovery of device information as well as provide timestamps that may be analyzed to determine relative positions of mobile devices in an arrangement.

Given that device information discloses the locations of transceivers 103-106 relative to the display of first device D1 and the locations of transceivers 109-112 relative to the display of second device D2, the calculated distances between transceivers 103-106, 109-112 are used to determine the physical arrangement of displays of devices in arrangement 113. The level of detailed information that needs to be known depends on the image application. For example, related displays, such as different game pieces displayed on different devices may not require the same level of detailed information and analyses as an image application that partitions a single image into a plurality of images for aggregate display of a video.

Image selector 119 selects the image(s) to be displayed on the displays of first and second devices D1, D2, and any other devices forming part of arrangement 113. Image selector may base selection decisions on the detected arrangement alone or in combination with one or more manually or automatically determined factors, such as but not limited to, the number of devices in the arrangement, the types of devices in the arrangement (e.g. touchscreen, non-touchscreen), the shape formed by the arrangement, a type or category of image being displayed (e.g. 2D, 3D, still, moving), the type of image application being run (e.g. passive video, interactive game), a display mode (e.g. display entire image or permit obstructions), display settings, scaling, zooming or magnification, centering, user input and other factors that may influence display.

Coordinated display applications running on one or more mobile devices and/or a server may have one or more display modes offering different viewing perspectives and, accordingly, different image processing. For example, a viewing perspective may account for or ignore non-display area (e.g. device frames, protective covers and gaps between devices) relative to an aggregate display of an image (e.g. video). If non-display area is considered part of the aggregate display, then portions of an overall image would be appear to be missing, i.e., hidden as if looking through a window divided with muntins. While this mode may avoid image distortion, it may interfere with some image displays depending on display settings and the image being displayed. For example, attempting to display a sports game as an image displayed on twelve cell phones in a rectangular arrangement at a scale where players are smaller than divisions between device displays in a display mode with obstructions may result in device frames and spacing significantly obstructing the game. Automated or manual entry of display settings may provide for appropriate display.

### IV. Exemplary Computer

FIG. 3 shows a block diagram of an exemplary computer 300 that may coordinate multiple mobile device displays. As previously indicated, computer 300 is one of many possible embodiments of each of first device D1, second device D2 and server 116. Embodiments, including systems, methods/processes, and/or apparatuses/devices, may be implemented using well known computers, such as computer 300.

Components of computer 300 may include, but are not limited to, central processor 318, memory 306 and system bus 324. System bus 324 couples various system components, including memory 306, to central processor 318. System bus 324 also couples graphics processor 320, media controller(s) 322, sensor interface 326, user interface 330, wireless interface 334 and wired interface 338. System bus 324 may be any of several types of bus structures including a memory bus or memory controller, a peripheral bus, and a local bus using any of a variety of bus architectures.

Central processor 318 may comprise one or more processing units to process executable instructions, which may be stored in cache(s) in central processor 318 or in memory 306, media 323, remote memory (not shown) or other memory (not shown). There are many ways to implement the technology as various types of software, including but not limited to a program, application, operating system, application programming interface (API), tool kit, driver code, standalone or downloadable software object, etc. Each of these may be stored in memory 306, media 323, remote memory (not shown) or other computer readable media.

Graphics processor 320 is coupled to system bus 324 and display 321. Graphics processor 320 may have its own memory, but may also access memory 306 and media 323. Graphics processor 320 may communicate with central processor 318 and assume responsibility for accelerated graphics port (AGP) communications. Graphics processor may comprise one or more graphics processing units (GPUs) that perform image processing, such as display coordination. Graphics processor 320 may provide audio to speakers (not shown) and images to display 321 for display to a viewer.

Memory 306 comprises any one or more types of volatile and non-volatile, removable and non-removable computer storage media. As illustrated without limitation, memory 306 may store basic input/output system (BIOS) 308, operating system 310, programs 312, applications 314 and data 316. Media controller(s) 322 accepts and controls one or more type of media 323. Media 323, i.e., computer readable media, can be any volatile and non-volatile, removable and non-removable media that can be accessed by computer 300. By way of example, and not limitation, computer readable media may comprise computer storage media and communication media.

Computer storage media includes any media that stores information, such as computer readable instructions, data structures, program modules or other data. Computer storage media includes, but is not limited to, RAM, ROM, EEPROM, flash memory and any other type of memory technology or memory devices in any format useful to store information accessible by computer 300.

Communication media is any non-storage media having computer readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Communication media is non-overlapping with respect to computer storage media.

User interface 330, comprising one or more interfaces, couples input device 332, comprising one or more input devices, to system bus 324. Input device 332 permits a user to enter commands and information into computer 300 through input devices, such as but not limited to one or more of a touchpad (e.g. touchscreen), keypad, gamepad, joystick, keyboard or pointing device. As one example, one or more input devices may be coupled to a universal serial bus (USB) or micro USB port.

Sensor interface 326 is coupled between system bus 324 and sensors 328. Non-limiting examples of sensors 328 include gyro, accelerometer, proximity, compass and global positioning system (GPS) sensors. For example, one or more sensors 328 may be used to determine arrangement 113 and/or trigger determination of arrangement 113.

As indicated in FIG. 3, computer 300 may operate in a networked, distributed or other environment involving communication with one or more remote computer(s) 342, which may or may not have similar features and components as shown for computer 300. Remote computer(s) 342 may, for example and without limitation, be mobile devices (e.g. first and second devices D1, D2), personal computers, servers (e.g. server 116), routers, or network nodes. In a networked or distributed environment, programs, applications and data depicted relative to computer 300, or portions thereof, may be stored in remote memory (not shown).

Computer 300 illustrates wired and/or wireless connections are possible to remote computer(s) 342. Wired interface 338 is coupled between system bus 324 and wired communication medium(s) 340 to remote computer(s) 342. Wired interface 338 and communication medium(s) 340 may be configured to handle any type and number of wired communication technologies and protocols, including mixed communication technologies and protocols. Wireless interface 334 is coupled between system bus 324 and transceiver 336 to remote computer(s) 342. Wireless interface 334 and transceiver 336 may be configured to handle any type and number of wireless communication technologies and protocols, including mixed communication technologies and protocols. Non-limiting examples of transceiver 336 include first device D1 transceivers 103-106, second device D2 transceivers 109-112 and communication device 114. It will be appreciated that the network or distributed connections shown are exemplary and other means of establishing communications with remote computers may be used in any embodiment.

### V. Exemplary Method of Coordinating Multiple Mobile Device Displays

Embodiments may also be implemented in processes or methods. For example,

FIG. 4 shows a flowchart of an exemplary embodiment of a method for coordinating multiple mobile device displays.

Embodiments described with respect to FIGS. 1 and 3 and/or otherwise in accordance with the technical subject matter described herein may operate according to method 400. Method 400 comprises steps 405 to 425 that may be performed in periodic or continuous operation. However, embodiments may operate in other ways. No order of steps is required unless expressly indicated or inherently required. There is no requirement that a method embodiment implement all of the steps illustrated in FIG. 4. FIG. 4 is simply one of many possible embodiments. Embodiments may implement fewer, more or different steps. Other structural and operational embodiments will be apparent to persons skilled in the relevant art(s) based on the description of method 400.

Method 400 begins with step 405. In step 405, on a continuous or periodic basis, an ad hoc physical arrangement of a plurality of mobile devices is determined The physical arrangement indicates relative positions of first and second mobile devices in the ad hoc physical arrangement. The mobile devices comprise first and second mobile devices. Each mobile device operates independently, has a display and is removable from the arrangement. Further, the arrangement can be rearranged. For example, as shown in FIGS. 1, 2a and 2b, arrangement 113, 2D arrangement 200a, 3D arrangement 200b or any other arrangement having first device D1, second device D2 and any number of other devices, is determined Display coordinator 117, specifically arrangement detector module 118, may make the determination of the arrangement. The determination may be implemented in computer executable instructions executed by computer 300. The determination of the arrangement may be made by any one or more device(s) in the arrangement, server 116 and/or another device (e.g. communication device 114 or another device that is not shown).

As previously discussed, the determination of an arrangement may be based on analysis of data provided by general or specific purpose sensors. Each device may be equipped differently and so the data set and analyses for various mobile devices in the arrangement may be different. While there are a wide variety of possible sensors, data sets and analyses, an example using transceivers is discussed with reference to first and second devices D1, D2 in FIG. 1. In one embodiment, first and second devices D1, D2 may engage in direct communications (e.g. via NFC, RFID, BT, WUSB, 60 GHz wireless), where first device D1 communicates with second device D2 by sending and receiving time stamped messages from each transceiver in first device D1 transceivers 103-106 to at least two transceivers in second device D2 transceivers 109-112.

As one example, the arrangement 113 may be determined from an analysis of time-stamped messages sent between transceiver 103 and transceivers 109-112, between transceiver 104 and transceivers 109-112, between transceiver 105 and transceivers 109-112, and between transceiver 106 and transceivers 109-112. In other embodiments, more or fewer communications may be necessary to determine a 2D or 3D arrangement. It is noted that RF delays in transmitters and receivers can be calibrated to make measurements more accurate. 2D arrangement 200a and 3D arrangement 200b may be determined by analyzing communications between the devices in those arrangements. User selection of a pattern or mount in advance of exploratory communications may reduce the complexity of communications and analyses to determine an arrangement. Communications may be analyzed by any one or more communication analysis techniques, e.g., TOA, TDOA, RTT, AOA and RSSI, to determine distances between transceivers. Given the distances and information about the devices, calculations may be performed to determine the arrangement of device displays.

At step 410, a first image to display on the first mobile device is determined based on the relative position of the first mobile device in the ad hoc physical arrangement. At step 415, a second image to display on the second mobile device is determined based on the relative position of the second mobile device in the ad hoc physical arrangement. For example, as shown in FIG. 1, display coordinator 117, specifically image selector 119, may determine which images are displayed on which devices in an arrangement (e.g. arrangement 113, 2D arrangement 200a, 3D arrangement 200b) based on information determined by arrangement detector 118. Image selection or determination may be based on the detected arrangement alone or in combination with one or more manually or automatically determined factors, such as but not limited to, the number of devices in the arrangement, the types of devices in the arrangement (e.g. touchscreen, non-touchscreen), the shape formed by the arrangement, a type or category of image being displayed (e.g. 2D, 3D, still, moving), the type of image application being run (e.g. passive video, interactive game), a display mode (e.g. display entire image or permit obstructions), display settings, scaling, zooming or magnification, centering, user input and other factors that may influence display.

At step 420, the first image is displayed on the first mobile device and the second image is displayed on the second mobile device. For example, as shown in FIGS. 5, 6, 7, 8a, 8b, 8c, 9a, 9b, 9c and 9d in arrangements 600, 700, 800a, 800b, 800c, 900a and 900b, images are displayed on devices in the arrangements.

### VI. Exemplary Display Modes

FIG. 5 shows an exemplary image that may be displayed by coordinated mobile device displays. Image 500 is a black circle. Of course, in other embodiments, any image(s) of any kind may be displayed on the displays of mobile devices in an arrangement. Image 500 may be any type of image, e.g., passive picture, sketch, video, animation or interactive form, video or game where viewer(s) may manipulate image(s) by providing user input to one or more devices in an arrangement or in another device (not shown). Embodiments described herein may partition image 500 into a plurality of images based on a particular arrangement of mobile devices, such as the arrangements shown in FIGS. 6 and 7.

FIG. 6 shows an exemplary mode of displaying the image shown in FIG. 5 by a plurality of coordinated mobile device displays that are the same. As used in this context, “same” may connote a uniformity of manufacturer and model type or a uniformity of display characteristics such as dimensions or the like. Arrangement 600 shows first through fourth mobile devices D1-D4 arranged in a rectangle and separated by a gap 605. For simplicity, each of first through fourth devices D1-D4 and the gaps between them, i.e., gap 605, are uniform. In other embodiments, the devices may be different (non-uniform) and gaps between them, if any, may be different. As shown in FIG. 6, the aggregate display formed by devices D1-D4 displays image 500 centered in the center of devices D1-D4. Portion 500n of image 500 is displayed on first device D1. Of course, if image 500 is part of a video, image 500 may move and be displayed disproportionately on devices D1-D4 in accordance with the video. Image settings, such as centering and scaling and display mode, may also be manually or automatically adjusted. It may be observed that the display mode in FIG. 6 counts non-display area between device displays as part of the aggregate display, which results in portions of image 500 being obscured by device frames and gaps 605 between devices.

FIG. 7 shows an exemplary mode of displaying the image shown in FIG. 5 by a plurality of coordinated mobile device displays that are different. As used in this context, “different” may connote a non-uniformity of manufacturer and model type or a non-uniformity of display characteristics such as dimensions or the like. Arrangement 700 comprises non-uniform mobile devices D1, D2 and D5. Compared to FIG. 6, second and fourth devices D2, D4 are replaced by fifth device D5 to illustrate non-uniform devices forming an arrangement, in this embodiment an aggregate display, created from non-uniform mobile devices. Of course, a visible advantage in obstruction mode is larger displays that cause fewer obstructions.

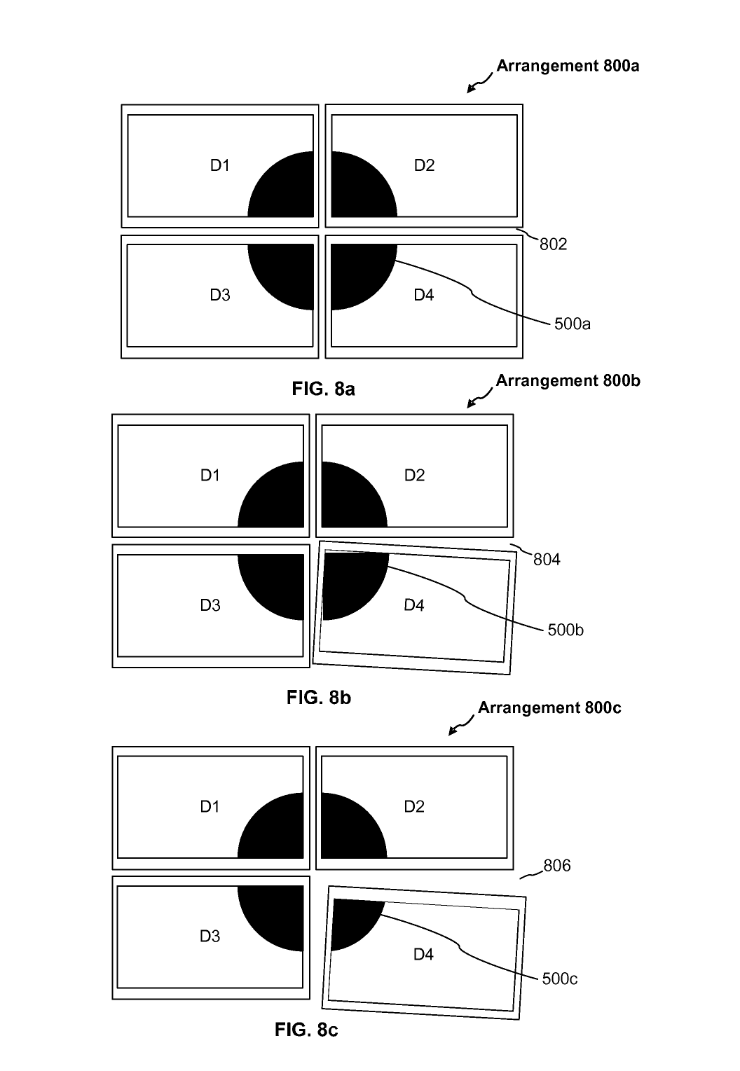

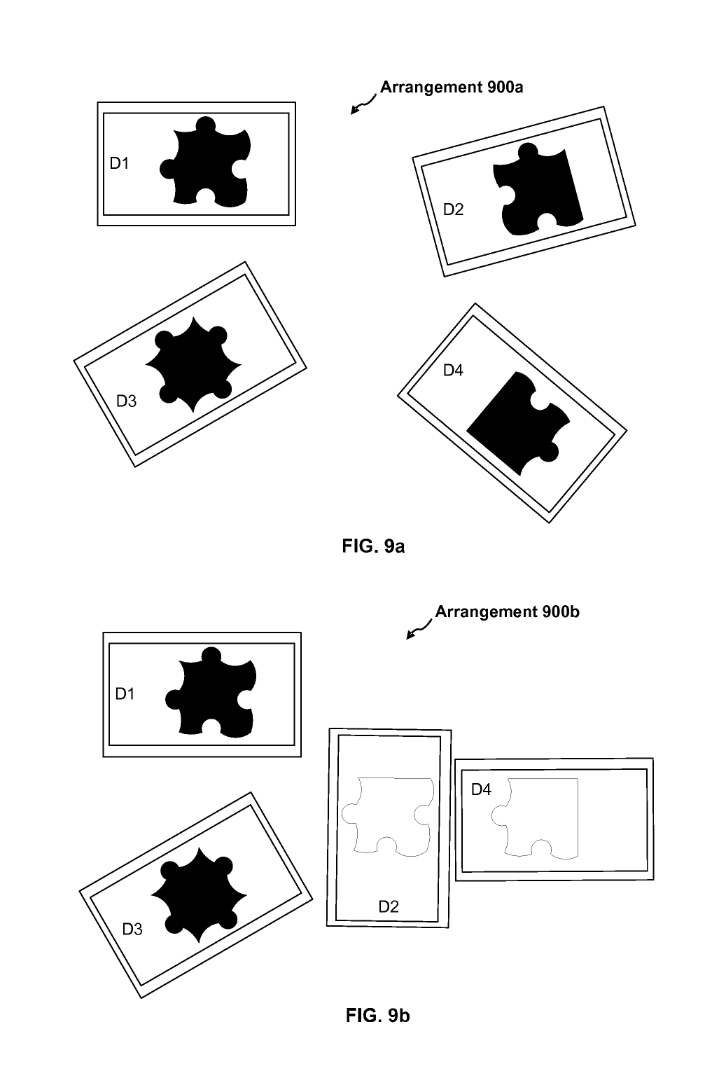

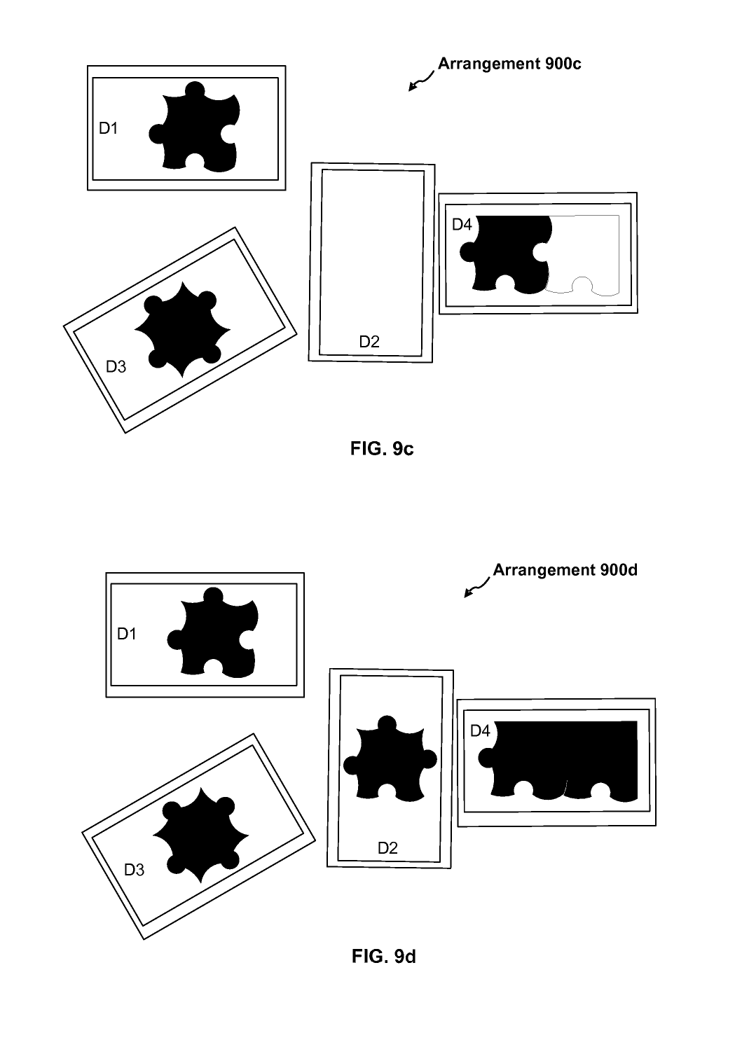

FIGS. 8a, 8b and 8c show an exemplary mode of displaying the image shown in FIG. 5 by a plurality of coordinated mobile device displays. In the embodiment shown in FIG. 8a, the display mode ignores non-display areas between device displays, including uniform gap 802. Image 500 is partitioned and displayed as if displays for devices D1-D4 were continuous without any device frames or gap 802 between them. Portion 500a is displayed by fourth device D4. As shown in FIG. 8a, this does create some distortion of image 500. However, this display mode may be suitable for some images.

In the embodiment shown in FIG. 8b, movement of fourth device D4 widens gap 802 into a non-uniform gap 804, creating arrangement 800b. If non-uniform gap 804 (or movement) is not taken into account then image 500 would be further distorted. As shown in FIG. 4, non-uniform gap 804 is taken into account, such that portion 500a remains in its original display position while fourth device D4 moves. This display mode of reacting to movement, or to arrangement 800b generally without movement, requires a different display on fourth device D4, as indicated by portion 500b.

The embodiment shown in FIG. 8c is an extension of the embodiment shown in FIG. 8b. Additional movement of fourth device D4 causes wider gap 806 and arrangement 800c. Taking wider gap 806 into account, the portioning of image 500 and display on fourth device D4 change again. As shown, portion 500c is displayed on fourth device D4 in order to avoid further distortion of image 500. Moving fourth device D4 back into the position shown in arrangement 800a would return the full ¼ image partition (i.e. portion 500a) to display on fourth device D4.

FIGS. 9a, 9b, 9c and 9d show an exemplary mode of displaying related images by a plurality of coordinated mobile device displays. In the embodiments shown in FIGS. 9a, 9b, 9c and 9d, an interactive still image game places related images (i.e. game pieces) on mobile devices in arrangements 900a and 900b. The underlying game may be designed for a single display or it may be designed for multiple displays. If the underlying game is designed for a single display then, as would be the case with display of an image on an aggregate display, an image would be partitioned and perhaps otherwise manipulated, e.g., by scaling, orientation, for distribution to and display by mobile devices in an arrangement.

In the embodiment shown in FIG. 9a, first through fourth devices D1-D4 are randomly arranged in arrangement 900a. Four game (e.g. puzzle) pieces are provided, respectively, for display by devices D1-D4. A user may accept these game pieces or provide user input to change one or more of the game pieces if the user/viewer does not see pieces that fit together. A user may also be enabled to interact with the display of each device. Such display interaction may be independent of other devices or may change the display by more than one device. For example, a user may provide user input to a device to zoom in or zoom out to, respectively, magnify a game piece or display additional game pieces. One or more devices may zoom in or out in response to interaction with one device. In this particular game, which is one of an infinite number of games that may be displayed, a user physically moves mobile devices to align game pieces.

In the embodiment shown in FIG. 9b, a user has moved both second device D2 and fourth device D4 to generally align game pieces and create arrangement 900b, which is detected by arrangement detector 118. Assembly of game (e.g. puzzle) pieces may be automatic upon such general alignment or may require manual input, such as pressing a button or touching a touchscreen. Thus, in some embodiments, arrangement alone may not modify display of an image. For example, a user input may be required to modify the display of related images.

In the embodiment shown in FIG. 9c, regardless whether it occurred automatically based on arrangement or based on the addition of manual user input, generally aligned game pieces displayed on second and fourth devices D2, D4 in arrangement 900b are combined and displayed on fourth device D4, leaving second device without an image to display, at least temporarily.

In the embodiment shown in FIG. 9d, a new game piece is displayed by second device D2. In some embodiments, the same game piece may be displayed on second device D2 regardless if it remains in the same place in arrangement 900b or is moved to a new position. In an implementation, a game piece may be provided to second device D2 at the same time the display on fourth device D4 changes to show assembled game pieces. Note that the arrangement in FIGS. 9b-d is the same; only the game pieces displayed are different. For this image application in this embodiment, the new game piece provided for display by second device D2 may not matter if device D2 is relocated to form a new arrangement. In other embodiments, a change in arrangement may matter in the selection of an image for display.

### VII. Conclusion

The technology herein generally addresses the problem that display screens on wireless devices are too small. However, because people often have more than one mobile device and/or congregate with other people with one or more mobile devices, multiple devices may be aggregated and arranged to form a larger display or related displays to display images, where an image is defined as any visual content. Images displayed by coordinated displays may be pre-divided for a plurality of devices, may be partitioned and distributed among the plurality of mobile devices or each device may select an image or a portion of an image so that each device displays an image, or portion thereof, based on its relative position in an arrangement of a plurality of mobile devices. As a result of display coordination, random configurations of mobile device displays may be adapted as display elements in a larger display or in a related display, such as game pieces, for passive viewing or interactive use by one or more viewers or users. Non-limiting examples of passive viewing include the display of pictures, videos, movies, and Web pages while non-limiting examples of interactive use include playing games (e.g. puzzles, reaction time games and video games).

A device (i.e., apparatus), as defined herein, is a machine or manufacture as defined by 35 U.S.C. §101. Devices may be digital, analog or a combination thereof.

Techniques, including methods, described herein may be implemented by hardware (digital and/or analog) or a combination of hardware with software and/or firmware component(s). Techniques described herein may be implemented by one or more components. Embodiments may comprise computer program products comprising logic (e.g., in the form of program code or software as well as firmware) stored on any computer useable medium, which may be integrated in or separate from other components. Such program code, when executed in one or more processors, causes a device to operate as described herein. Program code may be stored in computer-readable storage media. Examples of computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program logic, e.g., program modules, comprising computer executable instructions that, when executed, provide and/or maintain one or more aspects of functionality described herein with reference to the figures, as well as any and all components, steps and functions therein and/or further embodiments described herein.

Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as signals transmitted over wires. Embodiments are also directed to such communication media.

Proper interpretation of subject matter described herein and claimed hereunder is limited to patentable subject matter under 35 U.S.C. §101. Subject matter described in and claimed based on this patent application is not intended to and does not encompass unpatentable subject matter. As described herein and claimed hereunder, a method is a process defined by 35 U.S.C. §101. As described herein and claimed hereunder, each of a circuit, device, apparatus, machine, system, computer, module, media and the like is a machine and/or manufacture defined by 35 U.S.C. §101.

While various embodiments have been described above, it should be understood that they have been presented by way of example only, and not limitation. Embodiments are not limited to the functional blocks, detailed examples, steps, order or the entirety of subject matter presented in the figures, which is why the figures are referred to as exemplary embodiments. A device, apparatus or machine may comprise any one or more features described herein in any configuration. A method may comprise any process described herein, in any order, using any modality. It will be understood by those skilled in the relevant art(s) that various changes in form and details may be made to such embodiments without departing from the spirit and scope of the subject matter of the present application.

The exemplary appended claims encompass embodiments and features described herein, modifications and variations thereto as well as additional embodiments and features that fall within the true spirit and scope of the disclosed technologies. Thus, the breadth and scope of the disclosed technologies should not be limited by any of the above-described exemplary embodiments or the following claims and their equivalents.

What is claimed is:

1. A system comprising:
an arrangement detector that detects an ad hoc physical arrangement of a plurality of mobile devices, where each mobile device operates independently, has a display and is removable from the arrangement;
an image selector that selects a first image from a plurality of images to display on a first mobile device in the plurality of mobile devices based on a position of the first mobile device in the arrangement; and
the first mobile device, which displays the first image.

2. The system of claim 1, wherein the image selector partitions an image into a plurality of partitioned images, including the plurality of images, based on the arrangement.

3. The system of claim 1, further comprising:
a server that comprises the arrangement detector and image selector.

4. The system of claim 1, wherein the first mobile device comprises the image selector.

5. The system of claim 1, wherein the first mobile device comprises the arrangement detector.

6. The system of claim 1, further comprising:
a plurality of sensors, in the first mobile device, that sense information used by the arrangement detector to determine the physical arrangement.

7. The system of claim 1, wherein the arrangement detector detects the physical arrangement based on an analysis of communications between the plurality of mobile devices.

8. The system of claim 7, wherein each of the plurality of mobile devices comprise a plurality of transceivers used to generate the communications analyzed by the arrangement detector.

9. The system of claim 1, wherein the arrangement detector is triggered to re-detect the ad hoc physical arrangement in response to detection of movement by the first mobile device.

10. The system of claim 1, wherein the plurality of mobile devices are non-uniform.

11. A method comprising:
determining an ad hoc physical arrangement of a plurality of mobile devices indicating relative positions of first and second mobile devices in the ad hoc physical arrangement, where each of the plurality of mobile devices operates independently, has a display and is removable from the arrangement;
determining a first image to display on the first mobile device based on the relative position of the first mobile device in the ad hoc physical arrangement;
determining a second image to display on the second mobile device based on the relative position of the second mobile device in the ad hoc physical arrangement; and
displaying the first image on the first mobile device and displaying the second image on the second mobile device.

12. The method of claim 11, further comprising:
partitioning an image into the plurality of images, based on the arrangement.

13. The method of claim 12, further comprising:
determining that gaps between displays on the plurality of mobile devices obscure portions of the image.

14. The method of claim 11, wherein the sensing of the ad hoc physical arrangement comprises:
determining the relative positions of the plurality of mobile devices by analyzing a plurality of communications between the plurality of mobile devices.

15. The method of claim 11, wherein the plurality of devices are non-uniform.

16. The method of claim 11, wherein the ad hoc physical arrangement can be sensed among the group comprising two-dimensional and three dimensional arrangement.

17. The method of claim 16, further comprising:
inserting each of the plurality of devices into a form that arranges the plurality of mobile devices.

18. The method of claim 11, further comprising:
re-sensing the ad hoc physical arrangement in response to the first mobile device detecting movement.

19. The method of claim 11, further comprising:
sending, by a server, the first image to the first mobile device.

20. A device comprising:
memory storing computer executable instructions that, when executed by a processor:
sense an ad hoc physical arrangement of a plurality of mobile devices, where each mobile device operates independently, has a display and is removable from the arrangement;
select a first image from a plurality of images to display on a first mobile device in the plurality of mobile devices based on a position of the first mobile device in the arrangement; and
display the first image on the first mobile device.
